(19) United States
(12) Patent Application Publication
(10) Pub. No.: US 2025/0171079 A1
(43) Pub. Date: May 29, 2025

(54) AGRICULTURAL MACHINE

(71) Applicants: KRONE AGRICULTURE SE, SPELLE (DE); LEMKEN GMBH & CO. KG, ALPEN (DE)

(72) Inventors: HANNES MAEHLMANN-DUNKER, NEUENKIRCHEN (DE); STEFAN MAESING, BORKEN (DE)

(73) Assignees: KRONE AGRICULTURE SE, SPELLE (DE); LEMKEN GMBH & CO. KG, ALPEN (DE)

(21) Appl. No.: 18/938,309

(22) Filed: Nov. 6, 2024

(30) Foreign Application Priority Data
Nov. 9, 2023 (DE) 10 2023 131 190.5

(51) Int. Cl. B62D 13/04; B62D 7/14

(52) U.S. Cl. CPC B62D 13/04; B62D 7/144

(57) ABSTRACT

An agricultural machine includes a frame, a steerable front axis, a steerable rear axis, a trigger element which is deflectable depending on a front axis deflection, and a transmission device having a trigger part and a steering part. The steering part steers the rear axis. The trigger element acts on the trigger part and at least partially deflects the trigger part in a deceleration steering mode of the agricultural machine when an absolute amount of the front axis deflection exceeds a threshold value. The transmission device deflects the rear axis in an opposite direction to the front axis as a result of the at least partial deflection of the trigger part and by transmitting a force from the trigger part to the steering part.

### CROSS REFERENCE TO PRIOR APPLICATIONS

Priority is claimed to German Patent Application No. DE 10 2023 131 190.5, filed Nov. 9, 2023. The entire disclosure of said application is incorporated by reference herein.

### FIELD

The present invention relates to an agricultural machine, to a steering system for an agricultural machine, and to a steering method.

### BACKGROUND

Agricultural machinery that is pulled by a tractor during field processing and self-propelled agricultural machinery that is controlled by a driver during field processing have long since been known. These machines can also be moved in the same way during transfer journeys or road travel, i.e., on the way to or from the field, either pulled by the tractor or steered by the driver. On towed agricultural machinery, the brake is supplied with power and controlled from the towing vehicle. If available, it is also possible to steer one or more steerable axes of the towed agricultural machine from the towing vehicle. Autonomous agricultural machines are also increasingly being used which have their own drive and steering and which perform field processing independently without control commands from an operator. These vehicles cannot carry out a transfer journey autonomously in road traffic so that a different transportation concept is required. The agricultural machine can, for example, be loaded onto a low-loader. This is, however, time-consuming and increases the cost of the entire operation.

One possible alternative is to attach the agricultural machine to a towing vehicle for a transfer journey, similar to a trailer. Because the autonomous agricultural machine has at least one steerable axis, it must also be steered during the transfer journey. This could be performed by signal transmission from the towing vehicle which requires compatible communication systems in both vehicles. Depending on the manufacturer, model and year of production, this is not always provided. The autonomous agricultural machine can alternatively steer independently to a certain extent, whereby its steering must be based to a certain extent on the driving maneuvers of the towing vehicle. This can be achieved by a steering system that uses sensors to detect the position and movements of the towing vehicle and which derives commands for the steering actuators of the agricultural machine. Such a system can, however, be complex and cost-intensive under certain circumstances. Movements of the towing vehicle can also be transferred to the steering of the agricultural machine via a mechanical coupling. This is in principle reliable and can be implemented cost-effectively. Such a system does not, however, allow for adapted steering behavior. However, in some situations, for example, when maneuvering in confined spaces, stronger steering on the part of the agricultural machine is advantageous, while in other situations, for example, when driving at higher speeds, less steering contributes to stabilization.

### SUMMARY

An aspect of the present invention is to provide a situation-adapted steering system for a towed agricultural machine.

In an embodiment, the present invention provides an agricultural machine which includes a frame, a front axis which is configured to be steerable, a rear axis which is configured to be steerable, a trigger element which is configured to be deflected depending on a front axis deflection of the front axis, and a transmission device comprising a trigger part and a steering part. The steering part is configured to steer the rear axis. The trigger element is further configured to act on the trigger part and to at least partially deflect the trigger part in a deceleration steering mode of the agricultural machine when an absolute amount of the front axis deflection exceeds a threshold value. The transmission device is configured to deflect the rear axis in an opposite direction to the front axis as a result of the at least partial deflection of the trigger part and by transmitting a force from the trigger part to the steering part.

### BRIEF DESCRIPTION OF THE DRAWINGS

The present invention is described in greater detail below on the basis of embodiments and of the drawings in which:

FIG. 1 shows a bottom view of an agricultural machine according to the present invention with parts of a connection system in a first state;

FIG. 2 shows a bottom view of an agricultural machine according to the present invention with parts of a connection system in a second state;

FIG. 3 shows a diagram of a transmission device of the agricultural machine from FIG. 1 in a deceleration steering mode;

FIG. 4 shows a diagram of the transmission device from FIG. 3 in a single steering mode;

FIG. 5 shows a side view of a part of the agricultural machine from FIG. 1, a towing vehicle, and the connection system;

FIG. 6 shows a detailed perspective view of the connection system from FIG. 5;

FIG. 7 shows a detailed perspective view of the connection system from FIG. 5 in a first state; and

FIG. 8 shows a detailed perspective view of the connection system from FIG. 5 in a second state.

### DETAILED DESCRIPTION

The present invention provides an agricultural machine having a frame, a steerable front axis, a steerable rear axis, a trigger element which can be deflected as a function of a front axis deflection of the front axis, and a transmission device having a trigger part and a steering part, which is set up to steer the rear axis, wherein in a deceleration steering mode of the agricultural machine, the trigger element is set up to act on the trigger part and to deflect it, at least partially, when an absolute amount of the front axis deflection exceeds a threshold value, and the transmission device is set up to deflect the rear axis in the opposite direction to the front axis as a result of the at least partial deflection of the trigger part and by transmitting force from the trigger part to the steering part.

The agricultural machine can also be referred to as an agricultural work machine. It can in particular be a harvesting machine such as a forage harvester, a combine harvester, a baler, or a loader wagon. It could also be, for example, a tedder, a plough, a fertilizer spreader, a slurry tanker or similar. The agricultural machine is set up for field processing, for example, for ploughing, fertilizing, mowing, tedding, picking up crops or the like. The agricultural machine can be set up for coupling various attachments, such as a plow, a tedder, a cutterbar or similar. The actual vehicle body of the agricultural machine may, however, under certain circumstances, not be set up for any specific field processing. It can, however, have coupling structures such as a three-point hoist which can be used to couple an attachment adapted to the respective field processing. The agricultural machine is therefore also set up for field processing in this case. The agricultural machine can be a trailer that is pulled by a tractor during field processing. The agricultural machine can, for example, have its own power drive which drives the agricultural machine during field processing. The agricultural machine can, for example, be designed as an autonomous vehicle which is set up to carry out field processing without control commands from a driver or operator. It is also conceivable, however, for the agricultural machine to have a control stand or driver's cab and to be controlled by a driver if required.

The components described below can be regarded as parts of a steering system of the agricultural machine. The frame is generally rigid and can consist of a number of rigidly connected individual elements. It forms a mechanically stable base on which other components of the agricultural machine and/or the steering system can be arranged. The agricultural machine has at least one front axis and one rear axis, both of which are steerable. This includes the possibility that a plurality of front axes and/or a plurality of rear axes are provided. The axes mentioned are parts of a chassis and can, for example, be connected directly or indirectly to the frame. The terms “front axis” and “rear axis” refer to different positions in relation to the direction of travel of the agricultural machine, i.e., in relation to the longitudinal axis of the vehicle. The terms “front axis” and “rear axis” more precisely refer to the direction of travel that is intended for the deceleration steering mode of the agricultural machine. This can be identical to the direction of travel intended for field processing. It can, however, also be aligned in the opposite direction. As will be explained below, the agricultural machine can, for example, be towed by a towing vehicle in the deceleration steering mode. It would be conceivable to maintain the direction of travel intended for field processing, however, it would also be conceivable to pull the agricultural machine backwards so that the front axis in deceleration steering mode represents the rear axis during field processing and vice versa. Each of the axes can, for example, have two wheels which are spaced along a transverse axis of the agricultural machine, however, it is not excluded that, for example, an axis has only one wheel or two wheels that are so close together that they behave like a single wheel. The respective axis is steerable, which means that the alignment of each wheel of the axis in relation to the frame can be changed according to a swiveling movement. Two wheels can in principle swivel around a common swivel axis, corresponding to turntable steering. Each wheel can, for example, be deflected about its own swivel axis, whereby the respective steerable axis can in particular have an Ackerman steering.

The trigger element can be deflected depending on the front axis deflection of the front axis. This means that the front axis deflection influences the deflection of the trigger element. It can also be said that a trigger element deflection of the trigger element is causally dependent on the front axis deflection. There can, for example, be a clear correlation between the trigger element deflection and the front axis deflection so that a specific value of the trigger element deflection can be clearly assigned to a specific value of the front axis deflection and vice versa. The front axis deflection can, for example, correspond to a steering angle of the front axis. Depending on the embodiment, however, two wheels of the front axis can be aligned parallel or even non-parallel to each other. In the latter case, no clear steering angle can be specified, however, the mean value of the steering angles of the wheels can, for example, be defined as the steering angle of the front axis. The front axis deflection and in particular the steering angle of the front axis are based on straight-ahead driving, which corresponds to a deflection of 0 and a steering angle of 0°. The term “trigger element” is to be understood purely functionally and does not mean that the trigger element must be designed in one piece or must itself be rigid. The trigger element can, for example, be mechanically coupled to the front axis, whereby the term “mechanical” in this context also expressly includes “fluid-mechanical”. A fluid-mechanical coupling can be pneumatic or in particular hydraulic.

The transmission device has a trigger part and a steering part. As will be explained, the transmission device is used to transmit a force and/or a movement, with the transmission taking place from the trigger part to the steering part. In addition to the trigger part and the steering part, the transmission device can have a middle part or intermediate part. The terms “trigger part”, “steering part” and “intermediate part” are to be understood functionally with regard to the transmission path and do not imply any spatial arrangement. Each of the aforementioned parts can have one or more elements, which can also be movable in relation to each other. Embodiments are also conceivable in which an element cannot be clearly assigned to one of the parts but is, for example, partly assigned to the trigger part and partly to the steering part (or the intermediate part, if present). The steering part is designed to steer the rear axis, i.e., to deflect the rear axis. As with the front axis, a rear axis deflection, in particular a steering angle of the rear axis, can, for example, be defined. The rear axis deflection can be changed using the steering part. Embodiments are conceivable in which no clear demarcation between the steering part and the rear axis is possible.

The deceleration steering mode is a mode of the agricultural machine in which a steering movement of the rear axis automatically follows a steering movement of the front axis, but only when the front axis deflection exceeds a threshold value. This means that as the front axis deflection increases, the corresponding coupling of the rear axis deflection is delayed, which is illustrated by the term “deceleration steering”. The agricultural machine can, for example, be set up for at least one further mode which is different from the deceleration steering mode. Within the scope of the present invention, however, the agricultural machine could also be set up only for the deceleration steering mode. In the deceleration steering mode of the agricultural machine, the trigger element is set up to actuate and at least partially deflect the trigger part when an absolute amount of the front axis deflection exceeds a threshold value. “Impacting” here refers to a mechanical impact, i.e., a mechanical influence. This means that there is contact between the trigger part and the trigger element at least during the impact.

The impact causes the trigger part to be deflected either completely or partially. This can in particular refer to a deflection relative to the frame and/or to the fact that one element of the trigger part is deflected relative to another element of the trigger part. The corresponding impact and deflection occur when the absolute value of the front axis deflection exceeds a threshold value. In this context, a front axis deflection to one side (e.g., to the left) is marked with a positive value, while a front axis deflection to the other side (e.g., to the right) is marked with a negative value. The impact is therefore independent of the side to which the front axis deflection occurs; it only depends on the absolute amount of the deflection. As already mentioned, the front axis deflection can in particular correspond to a steering angle of the front axis. The threshold value can in this case be between 2° and 20°, for example, between 6° and 12°. If the absolute value of the front axis deflection is below the threshold value, there can, for example, be no impact and/or deflection of the trigger part. It can be said that an interaction (relevant in the sense of the present invention) between the trigger element and the trigger part is causally linked to the exceeding of the threshold value.

The transmission device is designed to deflect the rear axis in the opposite direction to the front axis as a result of the at least partial deflection of the trigger part and by transmitting force from the trigger part to the steering part. Power is transmitted through the transmission device, which should not, however, be interpreted to mean that the force must remain unchanged. The force with which the trigger element acts on the trigger part can therefore be smaller or greater than the force with which the steering part acts on the rear axis. Power can be transmitted directly from the trigger part to the steering part or indirectly via the above-mentioned intermediate part. Motion is also transmitted, i.e., the at least partial deflection of the trigger part is converted into an at least partial deflection of the steering part. The two deflections can differ both in terms of direction and amount, i.e., the deflection on the steering part can be smaller or larger than on the trigger part. A force transmission in any case takes place, which implies a form of mechanical coupling between the trigger part and the steering part, whereby the term “mechanical” also expressly includes “fluid-mechanical”. The steering part deflects the rear axis, which happens as a result of the at least partial deflection of the trigger part. This means that the rear axis deflection is causally linked to the deflection of the trigger part. The transmission device can, for example, be set up to keep the rear axis in a neutral position, which corresponds to straight-ahead driving, when the trigger part is not impacted.

It is possible within the scope of the present invention for the trigger part to use an additional actuator to deflect the rear axis, which amplifies the transmitted force in the manner of a servomotor. However, the rear axis can, for example, be deflected exclusively by power transmission through the transmission device. The deflection required to deflect the rear axis is therefore based on the deflection work performed by the trigger element on the trigger part. The deflection of the rear axis is opposite to the deflection of the front axis, whereby the amounts of the two deflections generally differ. The rear axis is in any case deflected to the left when the front axis is deflected to the right, and vice versa. This supports driving through tight curves and reduces the curve radius. The rear axis is, however, only deflected when the front axis is deflected to a greater extent, and, for example, remains in a position that corresponds to straight-ahead driving when the front axis is deflected to a lesser extent. This helps to stabilize the agricultural machine at higher driving speeds, at which lower deflections of the front axis are typical in practice. In contrast, the threshold value (if selected appropriately) is only realized at lower speeds, at which the stabilization of the driving behavior is rather subordinate and instead the possibility of tighter curve radii offers advantages.

Since the deceleration steering system according to the present invention requires neither sensors for detecting the position of the front axis nor actuators with their own power supply for deflecting the rear axis, the deceleration steering system can be implemented at low cost and is insensitive to faults or power failures. The deceleration steering system can in this sense be realized completely passively. It therefore enables a reliable adaptation of the steering behavior to different situations, in particular to different speeds and the associated different curve radii.

The dependence of the rear axis deflection on the front axis deflection above the threshold value can be realized in different ways. It can, for example, be linearly dependent on the front axis deflection or non-linear. It can in any case be provided that the rear axis deflection reaches the same value when the front axis deflection reaches a maximum value due to the design. A maximum steering angle of the rear axis can, for example, correspond to a maximum steering angle of the front axis.

As already mentioned above, the deceleration steering mode can, for example, be intended for a situation in which the agricultural machine is pulled by a towing vehicle. This can be particularly useful for road travel or for the transfer journey of an agricultural machine that is working autonomously as part of field processing. A embodiment of the present invention provides that the agricultural machine can, for example, have a drawbar element which can be swiveled relative to the frame about a drawbar axis and which is set up for at least an indirect coupling to a towing vehicle pulling the agricultural machine and for transmitting a tractive force, wherein the front axis is positively steered by the drawbar element in deceleration steering mode. The towing vehicle itself can be an agricultural machine, but it can also be another vehicle, for example, a truck. The towing vehicle is normally a motor vehicle with its own power drive, but it could also be, for example, a trailer without its own drive that is towed in turn. It can be a vehicle that is driven by a driver or an autonomous vehicle. The drawbar element can form a drawbar which is coupled to the towing vehicle, is a part of such a drawbar, or it can be designed to be connected to such a drawbar. It is designed to transmit the tractive force acting between the towing vehicle and the agricultural machine, i.e., the power flow passes through the drawbar element. It can be swiveled about a drawbar axis relative to the frame, with the drawbar axis, for example, running parallel to a vehicle vertical axis. If the drawbar element is coupled directly or indirectly to the towing vehicle, changes in the position of the towing vehicle, for example, when cornering, lead to a swiveling movement of the drawbar element. The front axis is positively steered by the drawbar element in the deceleration steering mode, i.e., the deflection of the drawbar element around the swivel axis determines the front axis deflection. For this purpose, the drawbar element can, for example, be mechanically coupled to the front axis. Such a mechanical coupling can in turn be realized entirely or partially fluid-mechanically. The drawbar element can, for example, control a hydraulic cylinder, which is in turn hydraulically connected to the steering cylinder of the front axis.

The drawbar element can in particular be part of a connection system for connecting the agricultural machine to the towing vehicle. The connection system has a drawbar unit which has a support part for supporting the towing vehicle and a drawbar boom which is at least indirectly connected to the support part and which can be swiveled relative thereto about a front drawbar axis, as well as the drawbar element, the drawbar axis of which can also be referred to as the rear drawbar axis in this context. Mutually corresponding coupling elements are in this case arranged on the drawbar boom and on the drawbar element which are designed to couple the drawbar boom and the drawbar element at least translationally in a locking position when they are arranged in a coupling position relative to one another, at least one coupling element being adjustable into a trigger position in order to release the drawbar boom from the drawbar element. The drawbar boom and drawbar element are translationally coupled and, for example, translationally locked, i.e., secured against translational displacement. The connection can, however, have at least one rotational degree of freedom, in particular exactly one rotational degree of freedom.

It can in particular be provided that at least one first stop coupling element is rigidly connected to the drawbar element and at least one second stop coupling element is rigidly connected to the drawbar boom so as to form a positive fit with the at least one first coupling element in the coupling position, wherein at least one actuating coupling element is adjustable between the locking position and the release position. At least one actuating coupling element can likewise be adjustably connected to the drawbar boom and, in the locking position, at least one first stop coupling element can be positively engaged between an actuating coupling element and a second stop coupling element. The drawbar boom and the drawbar element can advantageously be guided into the coupling position in an at least partially horizontal coupling direction, with the stop coupling elements forming a positive fit in the coupling position, at least in the coupling direction. The connection system can have stationary first guide surfaces relative to the drawbar boom and stationary second guide surfaces relative to the drawbar element, which define a clearance between them transverse to the coupling direction, at least one guide surface being beveled at least in some areas relative to the coupling direction so that the clearance is reduced as the coupling position is approached.

A locking mechanism can be arranged on the drawbar boom, the locking mechanism having the at least one actuating coupling element and via which the at least one actuating coupling element can be operated remotely. The locking mechanism can have a control lever which is arranged to swivel on the drawbar boom, which is arranged at a distance from the at least one actuating coupling element and which is connected thereto in a force-transmitting manner, in particular, via at least one coupling rod. The at least one actuating coupling element can alternatively or additionally be actuated by the locking mechanism.

At least one actuating coupling element can be designed as a latching element. The latching element is designed to be elastically deflected out of the locking position against a restoring force when approaching the coupling position and to return to the locking position following the restoring force when the coupling position is reached.

According to an embodiment of the present invention, the drawbar boom can, for example, be swiveled about an at least partially horizontal mounting axis relative to the support part between a towing position and a mounting position, whereby it can, for example, be swiveled about the mounting axis by an actuator. The drawbar boom can also be locked in a central position relative to the front drawbar axis in relation to the support part, whereby it can, for example, be guided into the central position and/or locked in the central position by an actuator. The drawbar unit can have a swivel part connected to the support part so that it can swivel about the front drawbar axis, to which the drawbar boom is connected so that it can swivel about the mounting axis.

The connection system can have at least one monitoring sensor, in particular a camera, which is set up to monitor an approach to the coupling position. The connection system can also have at least one coupling sensor which is set up to determine when the locking position is reached and to send a locking signal to a machine control unit of the agricultural machine. The machine control unit of the agricultural machine can be set up to switch to a mode intended for road travel when the locking signal is received, in particular to the deceleration steering mode. It is also possible, however, for the agricultural machine to switch to the corresponding mode before the locking signal is received.

An embodiment of the agricultural machine according to the present invention provides that at least the front axis has an Ackerman steering. This means that the wheels on the front axis are mounted on steering knuckles, i.e., on wheel carriers that can be swiveled individually in relation to the frame. The steering knuckles can be connected to steering levers, which in turn are connected via a tie rod. Designs with two separate tie rods are also conceivable. In an embodiment, a continuous tie rod can, for example, form a piston rod of a steering cylinder of the front axis or the tie rods of the two steering knuckles are connected to the piston rod. The corresponding steering cylinder can be switched passively in the deceleration steering mode so as not to interfere with the forced steering of the front axis by the above-mentioned drawbar element. The rear axis can also have an Ackerman steering. A continuous tie rod can in this case also form a piston rod of a steering cylinder of the rear axis, or the tie rods can be connected to the piston rod. The drawbar element can, for example, be connected in an articulated manner to a steering knuckle via a drawbar tie rod. The drawbar tie rod can be connected to the drawbar element on the one hand and to the steering knuckle on the other. The connection to the steering knuckle can also be made via an intermediate steering lever. If the two steering knuckles are coupled to each other via at least one further tie rod, which can be referred to as the tie rod of the front axis, it is sufficient to connect the drawbar element to one steering knuckle. Depending on the geometry and arrangement of the elements involved, a deflection angle of the drawbar element can be smaller, larger, or identical to the steering angle of the front axis.

The trigger element can, for example, be connected to the drawbar element. This includes the possibility of a movable, e.g., articulated connection. The trigger element is, however, advantageously rigidly connected to the drawbar element. This means that in this case, the trigger element swivels together with the drawbar element. It is also possible that no clear demarcation between the trigger element and the drawbar element is possible as these can, for example, be at least partially formed by the same component.

In an embodiment of the present invention, the power transmission from the trigger part to the steering part can, for example, be interrupted in a single steering mode of the agricultural machine. The single steering mode provides that the rear axis deflection is basically independent of the front axis deflection. This means that the causality via the trigger element and the transmission device that exists in the deceleration steering mode does not exist in the single steering mode. This is achieved in this embodiment by interrupting the power transmission within the transmission device. This means that an impact on the trigger part by the trigger element does not affect the steering part or the rear axis. In addition to or as an alternative to an interruption of the power transmission, it would also be conceivable to adjust the setting and/or arrangement of the trigger element and/or the trigger part in the single steering mode so that no more impact occurs when the front axis deflection exceeds the threshold value. The single steering mode can in particular be provided for an autonomous agricultural machine during field processing, whereby the front axis and the rear axis are generally steered independently of each other depending on the situation. A machine control unit of the agricultural machine can, for example, control the setting of the above-mentioned steering cylinders of the front axis and rear axis.

An embodiment of the present invention provides that the trigger part can, for example, have at least one trigger cylinder and the steering part can, for example, have at least one steering cylinder, wherein each cylinder has a cylinder body for receiving a working fluid and a piston element which is displaceable relative thereto, and wherein, in the deceleration steering mode, at least one trigger cylinder is fluidically coupled to at least one steering cylinder. The piston element is arranged at least partially within the cylinder body and is designed to displace the working fluid contained in the cylinder body by displacement and/or to be displaced by a working fluid flowing into the cylinder body. One or more chambers can be defined within the cylinder body, which are partially defined by the piston element and whose volume changes accordingly depending on the position of the piston element. In the deceleration steering mode, at least one trigger cylinder is fluidically coupled to at least one steering cylinder, i.e., working fluid can be exchanged between the two cylinders. If working fluid is displaced from the trigger cylinder, for example, the working fluid flows into the steering cylinder and vice versa. This means that the movement of the piston element of one cylinder can cause the piston element of the other cylinder to move. The fluidic connection forms the basis of the power transmission between the trigger part and the steering part. The at least one trigger cylinder and the at least one steering cylinder can, for example, be fluidically separated in single steering mode. The corresponding change can be made by switching a valve arrangement of the transmission device. The valve arrangement has at least one valve, possibly a plurality of valves. It is additionally or alternatively possible for the at least one trigger cylinder to be adjusted in the single steering mode so that it cannot be acted upon by the trigger element. The trigger cylinder can, for example, be swiveled for this purpose.

Embodiments are conceivable in which at least one cylinder is designed as a pneumatic cylinder. The compressibility of a gaseous working fluid could mean, however, that a deflection of a trigger cylinder cannot be transmitted precisely and without delay to a steering cylinder. This means that the steering behavior of the rear axis could be less predictable. For this reason, among others, the cylinders can, for example, be designed as hydraulic cylinders. This means that the above-mentioned working fluid is a hydraulic fluid.

In an embodiment of the present invention, the trigger element can, for example, have at least one trigger finger which is designed to act on and move the piston element of a trigger cylinder. This means that the piston element of the trigger cylinder, which can be referred to as the trigger cylinder's piston element, can be displaced relative to the cylinder body by the action of the trigger finger. The term “trigger finger” is not to be interpreted restrictively with regard to the shape and size of the element in question. The trigger finger can, however, be elongated at least in certain areas and/or tapered in cross-section in order to reach the piston element optimally and precisely. A separate trigger finger can be provided for each trigger cylinder. The trigger element can, for example, have two trigger fingers that extend in different directions in order to act on the piston elements of two trigger cylinders. Such trigger fingers can extend on both sides of the drawbar element and form a T-shaped structure together therewith. As the respective trigger finger does not move in a straight line but in an arc when rigidly connected to the drawbar element, the associated trigger cylinder can, for example, be mounted so that it can swivel in relation to the frame. The alignment of the trigger cylinder can thereby adapt to the movement of the trigger finger.

Embodiments are conceivable in which the trigger part is realized by a single trigger cylinder. Another embodiment provides for the trigger part to have two trigger cylinders, with the trigger element being set up to act on one trigger cylinder at a time depending on the direction of deflection of the front axis. This means that when the front axis is deflected in one direction (for example, corresponding to a positive front axis deflection), the trigger element acts on one trigger cylinder and, when the front axis is deflected in the opposite direction (for example, corresponding to a negative front axis deflection), the trigger element acts on the other trigger cylinder, provided in each case that the absolute value of the front axis deflection exceeds the threshold value. Although a different design of the two trigger cylinders is possible, the two trigger cylinders can, for example, be of the same type or mirror-symmetrical to each other. Their arrangement in relation to each other can also be mirror-symmetrical, in particular in relation to a vertical center plane of the agricultural machine. In this embodiment, it may in particular be provided that the trigger element has two trigger fingers, each of which is assigned to one of the two trigger cylinders.

There are various options with regard to the design of the respective trigger cylinder. At least one trigger cylinder can, for example, have a division wall which is arranged in the cylinder body and a piston element with a first piston part of the trigger cylinder and a second piston part of the trigger cylinder, which are connected via a piston rod of the trigger cylinder guided through the division wall, wherein a trigger cylinder's first chamber is defined between the first piston part of the trigger cylinder and the division wall and a trigger cylinder's second chamber is defined between the division wall and the second piston part of the trigger cylinder and, in the deceleration steering mode, both trigger cylinder's chambers are each fluidically connected to a steering cylinder. The piston element of the corresponding trigger cylinder therefore has at least three interconnected elements, namely, the two piston parts of the trigger cylinder and the piston rod of the trigger cylinder that connects them. The piston rod of the trigger cylinder can pass through at least one piston part and extend further on the side facing away from the other piston part. It is also possible that the piston rod consists of several parts that are not directly connected, but only via one of the piston parts. The piston parts have a cross-section that is adapted to the internal cross-section of the cylinder body so that they divide the cylinder body in a practically fluid-tight manner. The inside of the cylinder body is also divided by the division wall. The trigger cylinder's first chamber is defined between the first piston part of the trigger cylinder, and the trigger cylinder's second chamber is defined between the second piston part of the trigger cylinder and the division wall. Due to the connection of the piston parts via the piston rod, their distance from each other remains the same so that, when the piston element is displaced, either the volume of the trigger cylinder's first chamber increases while the volume of the trigger cylinder's second chamber decreases to the same extent, or vice versa. Accordingly, if the compressibility of the working fluid can be neglected, working fluid must flow into one chamber when working fluid is displaced from the other chamber. It can in particular be provided that the trigger element on the side of the first piston part of the trigger cylinder acts on the piston element when the threshold value is exceeded. The trigger finger mentioned above can in particular act there. The action can be indirect or direct on the first piston part of the trigger cylinder. Both trigger cylinder chambers are connected to a steering cylinder in the deceleration steering mode. In contrast, in the single steering mode, the first and second trigger cylinder chambers can, for example, be fluidically separated from the steering cylinder and (bypassing the steering cylinder) are fluidically connected to each other. Working fluid can accordingly be moved freely between the chambers in the single steering mode.

It is desirable for the rear axis to be returned to its neutral position when no impact is applied to a trigger cylinder by the trigger element. This reset can be accomplished in different ways, in particular via an active reset of the respective trigger cylinder. In an embodiment, at least one trigger cylinder can, for example, have a trigger cylinder's third chamber which is defined between the second piston part of the trigger cylinder and an end wall of the cylinder body and which communicates with a pressure accumulator in the deceleration steering mode, whereby the trigger cylinder can be returned to a home position. In this embodiment, the second piston part of the trigger cylinder is arranged in an area between the intermediate wall and the end wall and can move between these walls. The volume of the trigger cylinder's third chamber decreases when the volume of the trigger cylinder's second chamber increases and vice versa. The trigger cylinder's third chamber communicates with a pressure accumulator in the deceleration steering mode so that it is filled with pressurized working fluid. While a different working fluid could in principle here be used than in the trigger cylinder's chamber first and second chambers, the same working fluid can, for example, be used. The pressure accumulator can apply an at least approximately constant pressure to the trigger cylinder's third chamber. This strives to expand the trigger cylinder's first and third chambers and to compress the second chamber of the trigger cylinder. If, for example, no external force is exerted on the piston element by the trigger element, the second piston part of the trigger cylinder can be pushed all the way to the intermediate wall if necessary. The resulting position of the piston element of the trigger cylinder is referred to as the basic position of the trigger cylinder and/or the piston element. In single steering mode, the trigger cylinder's third chamber can, for example, be kept unpressurized. It can, for example, be connected to an unpressurized tank. The working fluid contained therein accordingly generates only a slight counterforce when the piston element is moved. The basic position of both trigger cylinders can, for example, correspond to the neutral position of the rear axis and/or the steering cylinder of the rear axis. This means that the transmission device can, for example, be set up to place the steering cylinder in a neutral position corresponding to straight-ahead driving when both trigger cylinders are in the home position. In other words, the steering cylinder can, for example, be set to the neutral position by adjusting the basic position of both trigger cylinders.

The steering part can, for example, have a steering cylinder with a first chamber of the steering cylinder and a second chamber of the steering cylinder, the second chamber being separated from the first chamber of the steering cylinder by a piston part of the steering cylinder, which is connected to a piston rod of the steering cylinder, via the deflection of which the rear axis can be deflected. The two chambers of the steering cylinder mentioned are defined within the cylinder body of the steering cylinder. They are separated by the piston part of the steering cylinder which belongs to the piston element of the steering cylinder. Moving the piston element thus increases the volume of one chamber of the steering cylinder while at the same time reducing the volume of the other chamber of the steering cylinder. End walls of the cylinder body can also be provided on the end side. The piston rod of the steering cylinder is connected to the piston part of the steering cylinder. The piston rod can pass through one end wall, for example, through both end walls. The piston rod accordingly extends outwards from the cylinder body. For example, as a tie rod, it can be part of an Ackerman steering of the rear axis, or it can be connected to tie rods on both sides. It is in any case designed to deflect the rear axis. The steering cylinder can, for example, be designed as a synchronized cylinder, whereby the cross-section of the first chamber of the steering cylinder is equal to the cross-section of the second chamber of the steering cylinder. This means that a chamber expands precisely when the fluid pressure in it is greater than the fluid pressure in the other chamber. The piston element can in any case be deflected by increasing the pressure in one of the chambers of the steering cylinder so that the piston rod deflects the rear axis.

In the deceleration steering mode, the trigger cylinder's first chamber of one trigger cylinder and the trigger cylinder's second chamber of the other trigger cylinder can, for example, be fluidically connected to the first chamber of the steering cylinder, and the trigger cylinder's second chamber of one trigger cylinder and the trigger cylinder's first chamber of the other trigger cylinder can, for example, be fluidically connected to the second chamber of the steering cylinder. The connections are of course selected so that the steering behavior is such that the rear axis is deflected in the opposite direction to the front axis. In this embodiment, the trigger cylinder's two chambers, which belong to different trigger cylinders, and one chamber of the steering cylinder form a fluidically interconnected subsystem. When the trigger element pressurizes the corresponding piston element of the trigger cylinder, the fluid pressure in this subsystem is increased and exceeds the fluid pressure in the other subsystem. This results in a deflection of the piston element of the steering cylinder, which in turn results in a deflection of the rear axis.

The present invention also provides a steering system for an agricultural machine, having a frame, a steerable front axis, a steerable rear axis, a trigger element which can be deflected as a function of a front axis deflection of the front axis, and a transmission device having a trigger part and a steering part, which is set up to steer the rear axis, wherein in a deceleration steering mode of the agricultural machine, the trigger element is set up to act on the trigger part and to deflect it, at least partially, when an absolute amount of the front axis deflection exceeds a threshold value, and the transmission device is set up to deflect the rear axis in the opposite direction to the front axis as a result of the at least partial deflection of the trigger part and by transmitting force from the trigger part to the steering part.

The aforementioned terms have already been explained with reference to the agricultural machine according to the present invention and will therefore not be explained again. Embodiments of the steering system correspond to those of the agricultural machine according to the present invention.

The present invention also provides a steering system for an agricultural machine, having a frame, a steerable front axis, a steerable rear axis, a trigger element which can be deflected as a function of a front axis deflection of the front axis, and a transmission device having a trigger part and a steering part, which is set up to steer the rear axis, wherein in a deceleration steering mode of the agricultural machine, the trigger element is set up to act on the trigger part and to deflect it, at least partially, when an absolute amount of the front axis deflection exceeds a threshold value, and the transmission device is set up to deflect the rear axis in the opposite direction to the front axis as a result of the at least partial deflection of the trigger part and by transmitting force from the trigger part to the steering part.

The aforementioned terms have already been explained with reference to the agricultural machine according to the present invention and will therefore not be explained again. Embodiments of the procedure correspond to those of the agricultural machine according to the present invention.

The present invention is described below with reference to the drawings. The drawings are thereby merely exemplary and do not limit the general idea of the present invention.

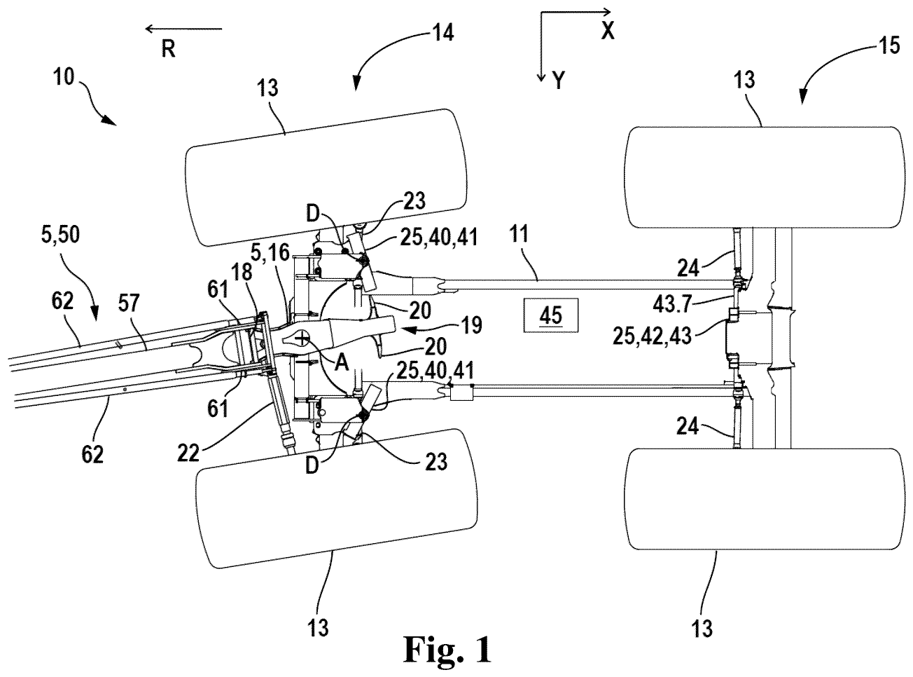

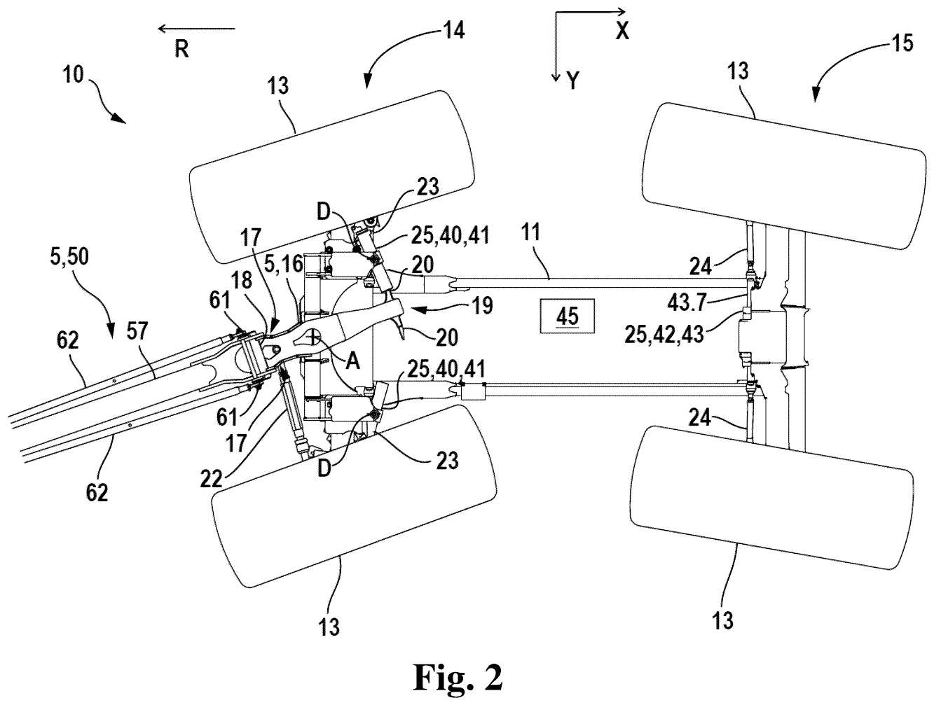

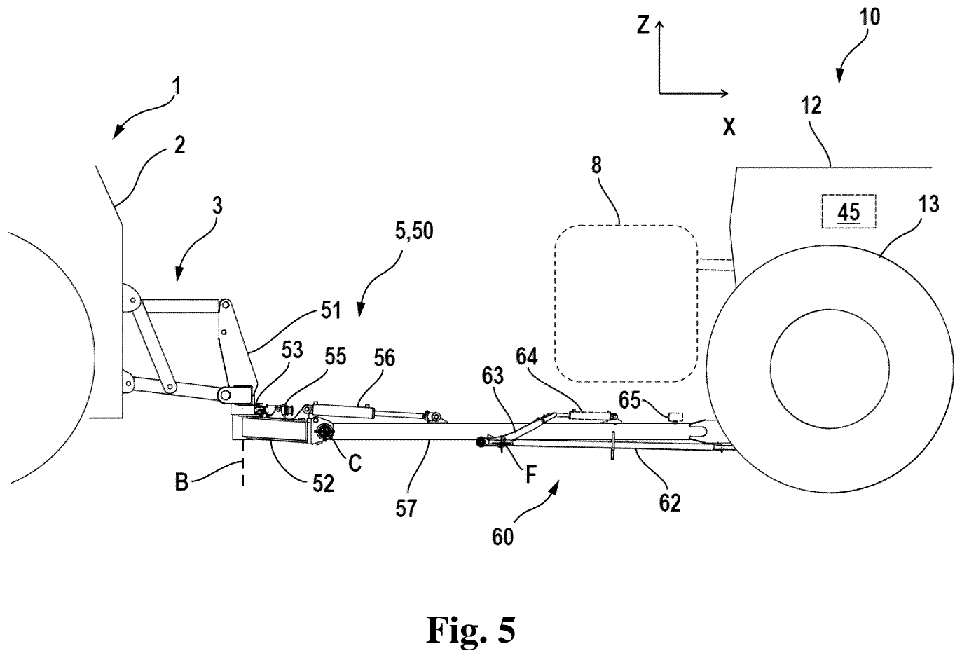

FIGS. 1 and 2 show views of an agricultural machine 10, which in this example is designed as an autonomous vehicle. A longitudinal axis X, a transverse axis Y, and a vertical axis Z of the agricultural machine 10 are shown here and in the following, as well as a direction of travel R pointing in the opposite direction to the longitudinal axis X. For simplification, various parts of the agricultural machine 10 have been omitted, in particular the majority of a vehicle body 12, which is indicated in FIG. 5. A frame 11 is recognizable, on which a steerable front axis 14 and a likewise steerable rear axis 15 are arranged, which is arranged behind the front axis 14 with respect to the direction of travel R. Both axes 14, 15 have two wheels 13 arranged next to each other in relation to the transverse axis Y. Each axis 14, 15 has one Ackerman steering, whereby a steering knuckle of the respective wheel 13 (which is not visible in the drawings) is steered via tie rods 23, 24. Tie rods 23 of the front axis 14 are coupled to a steering cylinder of the front axis (not shown for reasons of clarity), while tie rods 24 of the rear axis 15 are coupled to a steering cylinder of the rear axis 43, more precisely to a piston rod of the steering cylinder 43.7 of the same. During field processing, both axes 14, 15 are operated in a single steering mode, whereby a machine control unit 45 can steer each of the axes 14, 15 independently of one another depending on the situation via the respective steering cylinders 43.

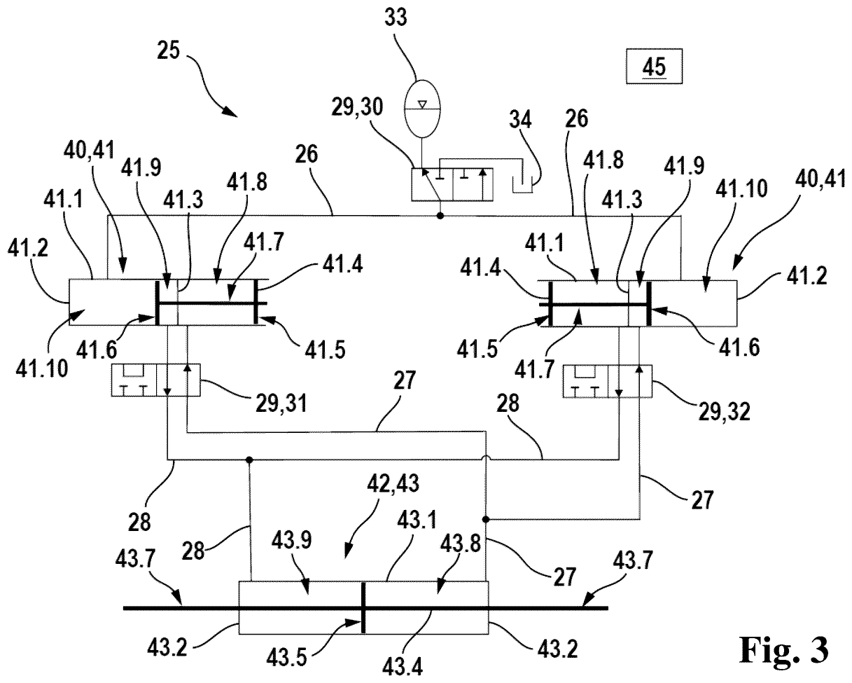

A drawbar element 16 is also arranged on the frame 11, which can be swiveled about a first or rear drawbar axis A running parallel to the vertical axis Z. The drawbar element 16 is connected to one of the steering knuckles of the front axis 14 via an articulated drawbar tie rod 22. Together with a drawbar unit 50, which will be explained below, the drawbar element 16 forms part of a connection system 5, via which the agricultural machine 10 can be connected to a towing vehicle 1. During road travel, when the agricultural machine 10 is being pulled by the towing vehicle 1, the agricultural machine 10 is operated in a deceleration steering mode. The steering cylinder of the front axis is switched passively and the steering of the front axis is completely determined by the deflection of the drawbar element 16 due to the forced coupling via the drawbar tie rod 22. At a rear end with respect to the longitudinal axis X, the drawbar element 16 has a trigger element 19 with two trigger fingers 20 projecting on both sides. Each trigger finger 20 is assigned to a trigger cylinder 41, which belongs to a trigger part 40 of a transmission device 25. The transmission device 25 is used to transmit steering movements of the front axis 14 to the rear axis 15 in a specific manner. Both trigger cylinders 41 are connected to the frame 11 so that they can swivel about vertically extending swivel axes of the trigger cylinder D. The steering cylinder of the rear axis 43 forms a steering part 42 of the transmission device 25. In the deceleration steering mode, the trigger cylinders 41 and the steering cylinder of the rear axis 43 are hydraulically connected to each other, as can be seen from the diagram in FIG. 3. Each trigger cylinder 41 has a cylinder body 41.1, which has an end wall 41.2 at one end and also a division wall 41.3. The division wall 41.3 is traversed by a piston rod of the trigger cylinder 41.7 of a piston element 41.4.

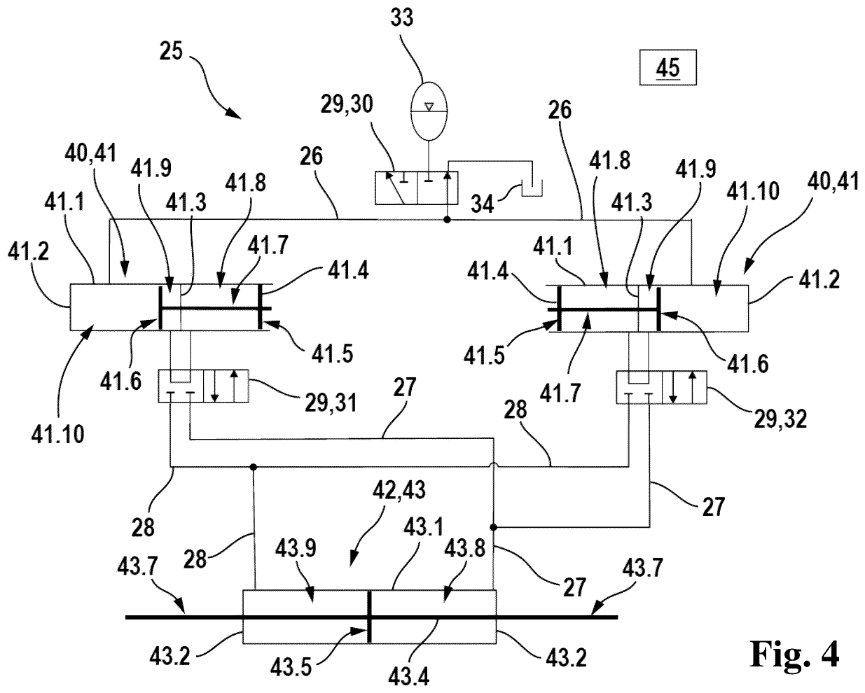

The piston element 41.4 also has two piston parts of the trigger cylinder 41.5, 41.6, which are rigidly connected by the piston rod of the trigger cylinder 41.7. A first piston part of the trigger cylinder 41.5 is formed between the division wall 41.3 and the trigger cylinder's first chamber 41.8, while a trigger cylinder's second chamber 41.6 is formed between the division wall 41.3 and the second chamber of the trigger cylinder 41.9. A third chamber of the trigger cylinder 41.10 is formed between the end wall 41.2 and the second piston part of the trigger cylinder 41.6. The trigger cylinder's third chambers 41.10 are connected to a first hydraulic branch 26. In the deceleration steering mode, this is connected to a pressure accumulator 33 via a first valve 30 of a valve arrangement 29. This maintains an essentially constant hydraulic pressure in the trigger cylinder's third chambers 41.10. The trigger cylinder's first chamber 41.8 of the trigger cylinder 41 on the left in FIGS. 3 and 4 is connected to a second hydraulic branch 27 via a second valve 31, while the trigger cylinder's second chamber 41.9 is connected to a third hydraulic branch 28 via the second valve 31. Similarly, the trigger cylinder's first chamber 41.8 of the trigger cylinder 41 on the right in FIGS. 3 and 4 is connected to the third hydraulic branch 28 via a third valve 32, while the trigger cylinder's second chamber 41.9 is connected to the second hydraulic branch 27 via the third valve 32.

The steering cylinder of the rear axis 43 has a cylinder body 43.1, which is bounded on both sides by end walls 43.2. The above-mentioned piston rod of the steering cylinder 43.7 of a piston element 43.4 is passed through the end walls 43.2. The piston element 43.4 has a piston part of the steering cylinder 43.5 which is rigidly connected to the piston rod of the steering cylinder 43.7. A first chamber of the steering cylinder 43.8 and a second chamber of the steering cylinder 43.9 are defined between the latter and one of the end walls 43.2 in each case. The first chamber of the steering cylinder 43.8 is permanently connected to the second hydraulic branch 27, while the second chamber of the steering cylinder 43.9 is connected to the third hydraulic branch 28. If the piston element 41.4 of the left trigger cylinder 41 is deflected in the direction of the end wall 41.2, the volume of the trigger cylinder's second chamber 41.9 increases, while the volume of the trigger cylinder's first chamber 41.8 decreases. Hydraulic fluid is displaced via the second hydraulic branch 27, while hydraulic fluid flows in via the third hydraulic branch 28. The piston element 43.4 of the steering cylinder of the rear axis 43 is accordingly deflected to the left in relation to FIG. 3. In a corresponding manner, a deflection of the piston element 41.4 of the right trigger cylinder 41 in the direction of the end wall 41.2 causes the piston element 43.4 of the steering cylinder of the rear axis 43 to be deflected to the right. As long as no external deflection of one of the piston elements 41.4 exists, these are held in a basic position due to the pressure in the trigger cylinder's third chamber 41.10, which can also be referred to as the basic position of the trigger cylinders 41. Due to the symmetrical design of the transmission device 25, this results in the steering cylinder of the rear axis 43 being held in a neutral position that corresponds to straight-ahead driving. This means that as long as none of the piston elements 41.3 of the trigger cylinder 41 is actively deflected, the rear axis 15 remains locked in a straight-ahead driving, which is particularly advantageous at high speeds.

Each of the trigger fingers 20 is designed to act on the piston element 41.4 of one of the trigger cylinders 41, or more precisely to apply force to it on the side of the first piston part of the trigger cylinder 41.5. FIG. 1 shows a state in which an absolute amount of a front axis deflection of the front axis 14 is below a certain threshold value, which is in particular typical at high speeds, as the drawbar element 16 is usually only deflected slightly at these speeds. An amount of a steering angle of the front axis can, for example, be 8°, while the threshold value is 10°. Both trigger fingers 20 are not in contact with the trigger cylinders 41, which is why the rear axis 15 remains in its neutral position. FIG. 2 shows a state in which the absolute value of the front axis deflection is above the threshold value. The amount of the steering angle of the front axis can, for example, be 17°. One of the trigger fingers 20 contacts the trigger cylinder 41 assigned to it and thus acts on the piston element 41.4 of the same. As described above, this leads to a deflection of the piston element 41.3 of the steering cylinder of the rear axis 43, whereby the wheels 13 of the rear axis 15 are deflected in the opposite direction to the front axis 14 via the tie rods of the rear axis 24.

FIG. 4 shows the transmission device in single steering mode. The first hydraulic branch 26 is connected to an unpressurized tank 34 via the first valve 30. The trigger cylinder's first chamber 41.8 and the trigger cylinder's second chamber 41.9 of the left trigger cylinder 41 are also connected to each other via the second valve 31 and at the same time are fluidically separated from the second hydraulic branch 27 and the third hydraulic branch 28. In the same way, the trigger cylinder's first chamber 41.8 and the trigger cylinder's second chamber 41.9 of the right trigger cylinder 41 are connected to each other via the third valve 32 and at the same time are fluidically separated from the second hydraulic branch 27 and the third hydraulic branch 28. This means that the piston element 41.4 of each trigger cylinder 41 can be moved freely and there is no hydraulic power transmission to the steering cylinder of the rear axis 43. This can be pressurized via additional hydraulic lines (not shown in FIGS. 3 and 4) in order to deflect the rear axis 15 according to the situation. Switching between the deceleration steering mode and the single steering mode can be performed by the machine control unit 45, as can the control of the two axes 14, 15 in the single steering mode. According to an alternative not shown in the drawings, each of the trigger cylinders 41 can be swiveled about the respective swivel axis of the trigger cylinder D so that it cannot be acted upon by the trigger element 19 in single steering mode.

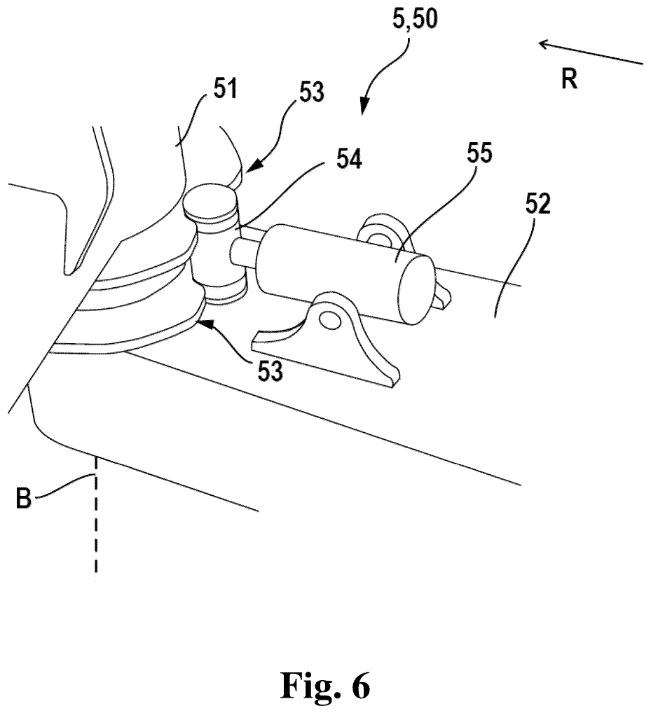

FIG. 5 shows the agricultural machine 10 connected to the towing vehicle 1, which can, for example, be a tractor, via the connection system 5 during road travel. A three-point hoist 3 is arranged on the vehicle body 2. As already mentioned, the connection system 5 has a drawbar unit 50. The latter is coupled to the three-point hoist 3 with a support part 51 and is supported thereon. A swivel part 52 is connected to the support part 51 so that it can swivel about a vertically extending second or front drawbar axis B. A drawbar boom 57 is connected to the swivel part 52 about a horizontally extending mounting axis C. As can be seen in the detailed view in FIG. 6, a locking cylinder 55 is arranged on the swivel part 52, via which a locking element 54 can be extended and retracted. FIG. 6 shows the locking element 54 in an extended position. The locking element 54 interacts with a curved track 53 fixed in position on the support part 51. The profile of the curved track 53 is designed so that extending the locking element 54 swivels the swivel part 52, including the drawbar boom 57 connected thereto, into a central position and holds it in this position. This can mean complete locking or elastic retention. In the latter case, although the swivel part 52 can be deflected from the center position to a limited extent by an external torque against a restoring torque, it is returned to the center position in the absence of the external torque. According to an alternative (not shown), the swivel part 52 could also be actively swiveled about the front drawbar axis B via a corresponding actuator. The actuator could then be used to set any position, especially the center position. The drawbar boom 57 is connected to the swivel part 52 by a setting cylinder 56. FIG. 5 shows the setting cylinder 56 in the extended position, with the drawbar boom 57 aligned approximately horizontally in a towing position. By retracting the setting cylinder 56, the drawbar boom 57 can be swiveled into an approximately vertical mounting position (not shown). This can be set when the towing vehicle 1 is driving on a road without the agricultural machine 10. This also places the swivel part 52 in the center position and holds it there.

According to a variant (not shown), the drawbar boom 57 can be swiveled relative to the support part 51 about a further swivel axis which can, for example, extend at an angle of 80° to 100°, in particular 90°, to the mounting axis C and which can, for example, also extend at an angle of between 70° and 100°, in particular 80° to 100°, to the horizontal plane at least in the towing position. The aforementioned swivel axis can in particular run parallel to the longitudinal axis of the drawbar boom 57, at least in the towing position. This could compensate for rotational relative movements around the longitudinal axis of the towing vehicle 1 and/or around the longitudinal axis X of the agricultural machine 10. In order to realize the swivel capability, the support part 51, the swivel part 52 and/or the drawbar boom 57 could be replaced by two parts that swivel against each other.

For road travel, the drawbar unit 50 can be coupled to the drawbar element 16 via interacting coupling elements 18, 58, 61. When the agricultural machine 10 has reached its operating position, the drawbar unit 50 is decoupled and the agricultural machine 10 can carry out field processing. A highly schematized attachment 8 (shown in FIG. 5) can, for example, be used for this purpose, which can, for example, also be coupled to the vehicle body 12 during road travel and is arranged comparatively close above the drawbar boom 57.

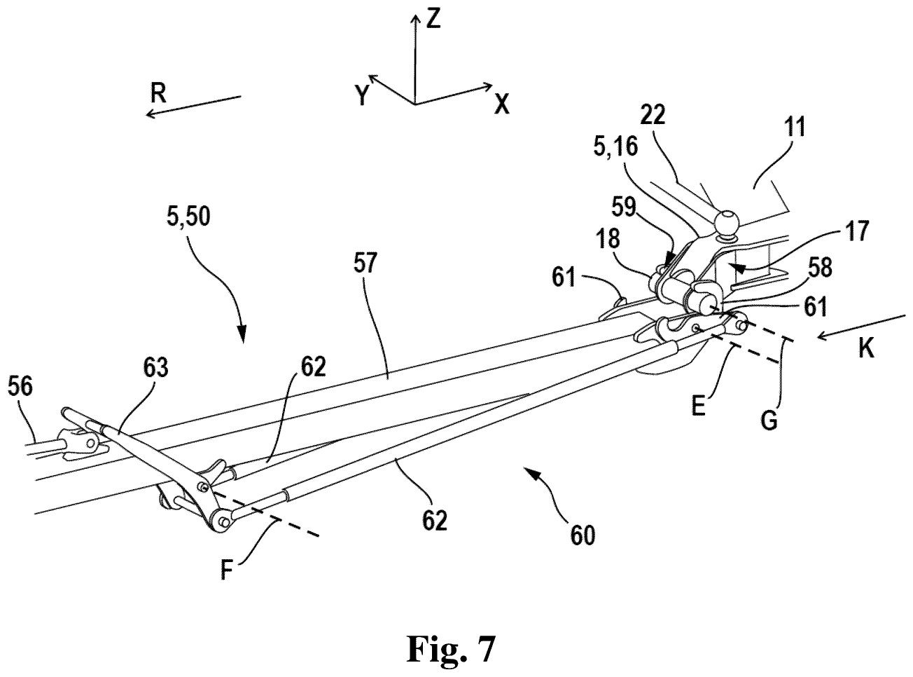

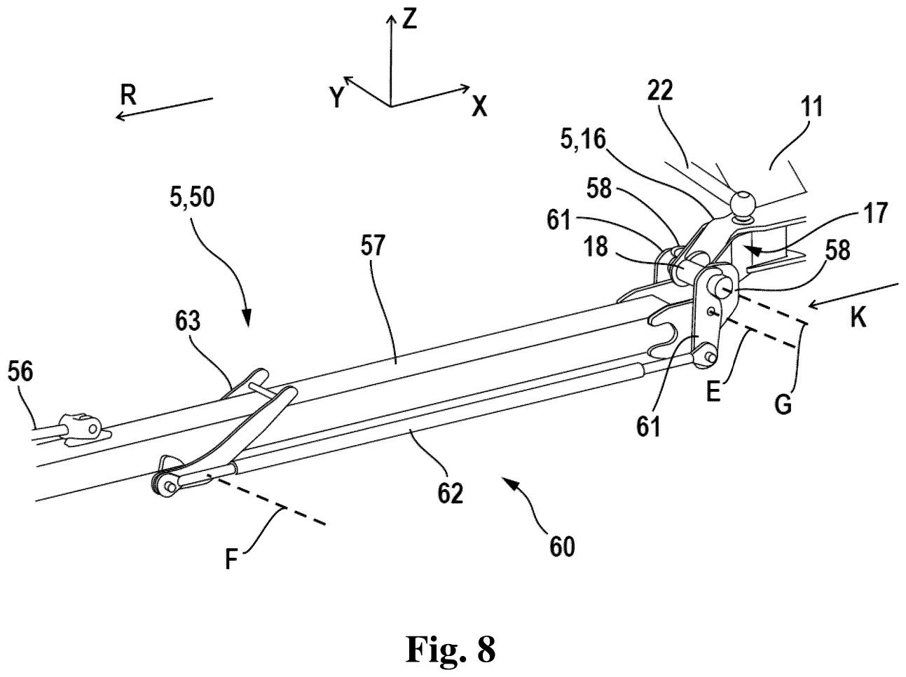

The coupling process is now explained with reference to FIGS. 7 and 8. A cylindrical first stop coupling element 18 is rigidly connected to the drawbar element 16. The drawbar boom 57 has two hook-like second stop coupling elements 58 at the ends, which are designed to engage around the first stop coupling element 18 from behind when the drawbar boom 57 and the drawbar element 16 are arranged relative to one another in a coupling position shown in FIGS. 7 and 8. For coupling, the second stop coupling elements 58 are first moved behind the first stop coupling element 18. For this purpose, the drawbar boom 57 can first be swiveled slightly downwards relative to the horizontal via the setting cylinder 56 so that the second stop coupling elements 58 can be passed under the first stop coupling element 18 while the towing vehicle 1 is reversing. The drawbar boom 57 is then swiveled into the horizontal position and the towing vehicle 1 can drive forward, with the drawbar boom 57 moving with the second stop coupling elements 58 relative to the drawbar element 16 along a coupling direction K, which in this case runs antiparallel to the longitudinal axis X. The width of the drawbar element 16 is matched to the lateral spacing of the second stop coupling elements 58 so that it is accommodated between them with virtually no play in the coupling position. The width of the drawbar element 16 increases with respect to the transverse axis Y along the coupling direction K, with first guide surfaces 17 extending at an angle to the coupling direction K on both sides of the drawbar element 16 and cooperating with second guide surfaces 59 formed by the second stop coupling elements 58. A clearance defined between the guide surfaces 17, 59 decreases along the coupling direction until it is negligibly small in the coupling position. This provides a virtually complete form fit in relation to the transverse axis Y.

The coupling between the drawbar unit 50 and the drawbar element 16 is completed via a locking mechanism 60. This has actuating coupling elements 61 arranged on both sides on the outside of the second stop coupling elements 58, which can be swiveled about a swivel axis of the coupling element E. They are connected via two coupling rods 62 to a rigid control lever 63, which is in turn connected to the drawbar boom 57 so that it can swivel about a swivel axis of the control lever F. Each coupling rod is rigid in itself and swivels on both sides. By swiveling the control lever 63, the actuating coupling elements 61 can be swiveled from a release position shown in FIG. 7 into a locking position shown in FIG. 8. In the locking position, the first stop coupling element 18 is enclosed between the second stop coupling elements 58 and the actuating coupling elements 61, i.e., there is a positive fit with respect to the longitudinal axis X, the transverse axis Y, and the vertical axis Z. The connection is also in particular torsion-proof with respect to the vertical axis Z, whereby swiveling movements on the part of the drawbar unit are transmitted directly to the drawbar element 16. The drawbar boom 57 and the drawbar element 16 are thus locked against each other in a translational and partially rotational manner. A rotational degree of freedom is, however, retained, since the drawbar boom 57 can swivel relative to the drawbar element 16 about a swivel axis of the coupling G, which runs horizontally through the first stop coupling element 18. When the locking position of the actuating coupling elements 61 is reached, this can be registered on the side of the drawbar element 16 by a coupling sensor (not shown), whereupon the machine control unit 45 of the agricultural machine 10 can automatically switch from single steering mode to the deceleration steering mode intended for road travel.

As can be clearly seen in FIG. 5, the coupling rods 62 are so long that the control lever 63 is still arranged in front of the attachment 8 with respect to the longitudinal axis X. A user accordingly does not have to reach into the confined space below the attachment 8 to operate the control lever 63. The length of each coupling rod 62, i.e., the distance between its swivel points, is not the same as the distance between the swivel axis of the coupling element E and the swivel axis of the control lever F, but is slightly greater. As a result, a swiveling of the control lever 63 is only possible with a slight deformation of the components involved, whereby an unstable point exists between the position shown in FIG. 7 and the position shown in FIG. 8 which must be overcome via a corresponding torque. The control lever 63 returns from the unstable point to the nearest position without external forces. This provides that the locking mechanism 60 is guided into the locking position and that it does not leave this position again without significant external forces.

The connection system 5 can optionally have a camera 65 or another sensor via which a driver of the towing vehicle 1 can monitor the coupling process. In FIG. 5, the camera is shown strongly schematized by a dashed line, whereby it is exemplarily arranged on the drawbar boom 57 in the vicinity of the drawbar element 16. However, it could also be arranged, for example, on the swivel part 52, on the support part 51, or even on the drawbar element 16. A wireless image transmission to the towing vehicle 1 could take place in the latter case. In order to further facilitate the operation of the locking mechanism 60, the connection system 5 can also have a control actuator 64, which is also shown dashed in FIG. 5, and which is attached to the drawbar boom 57 and to the control lever 63. It would in this case of course also be possible to redesign the locking mechanism 60 as a whole, whereby, for example, the long coupling rods 62 could be dispensed with. The control actuator 64 can advantageously be controlled from the tractor 1.

According to an alternative embodiment of the present invention which is not here shown, the locking mechanism 60 can also have an actuating coupling element 61 which is designed as a latching element which, when approaching the coupling position, is first elastically deflected by the first stop coupling element 18 from a rest position corresponding to the locking position and returns to the rest position when the coupling position is reached, whereby it establishes a positive fit with the first stop coupling element 18.

A further alternative of the present invention which is also not shown provides that the coupling direction K does not point forwards, but backwards in the direction of the longitudinal axis X, whereby the drawbar unit 50 can be brought into the coupling position by the towing vehicle 1 driving backwards towards the agricultural machine 10. Guide surfaces beveled with respect to the coupling direction K could in this case form a funnel through which the drawbar unit 50 with the at least one second stop coupling element 58 is guided automatically, so to speak, into the coupling position when reversing.

The present invention is not limited to embodiments described herein; reference should be had to the appended claims.

### LIST OF REFERENCE CHARACTERS

1 Towing vehicle
2 Vehicle body
3 Three-point hoist
4 Connection system
8 Attachment
10 Agricultural machine
11 Frame
12 Vehicle body
13 Wheel
14 Front axis
15 Rear axis
16 Drawbar element
17 First guide surface
18 First stop coupling element
19 Trigger element
20 Trigger finger
22 Drawbar tie rod
23 Tie rod of front axis
24 Tie rod of rear axis
25 Transmission device
26 First hydraulic branch
27 Second hydraulic branch
28 Third hydraulic branch
29 Valve arrangement
30 First valve
31 Second valve
32 Third valve
33 Pressure accumulator
34 Unpressurized tank
40 Trigger part
41 Trigger cylinder
41.1 Cylinder body
41.2 End wall
41.3 Division wall
41.4 Piston element
41.5 First piston part of the trigger cylinder
41.6 Second piston part of the trigger cylinder
41.7 Piston rod of the trigger cylinder
41.8 First chamber of trigger cylinder
41.9 Second chamber of trigger cylinder
41.10 Third chamber of trigger cylinder
42 Steering part
43 Steering cylinder of rear axis
43.1 Cylinder body
43.2 End wall
43.4 Piston element
43.5 Piston part of steering cylinder
43.7 Piston rod of steering cylinder
43.8 First chamber of steering cylinder
43.9 Second chamber of steering cylinder
45 Machine control unit
50 Drawbar unit
51 Support part
52 Swivel part
53 Curved track
54 Locking element
55 Locking cylinder
56 Setting cylinder
57 Drawbar boom
58 Second stop coupling element
59 Second guide surface
60 Locking mechanism
61 Actuating coupling elements
62 Coupling rod
63 Control lever
64 Control actuator
65 Camera
A Rear drawbar axis
B Front drawbar axis
C Mounting axis
D Swivel axis of trigger cylinder
E Swivel axis of coupling element
F Swivel axis of control lever
G Swivel axis of coupling
K Coupling direction
R Direction of travel
X Longitudinal axis
Y Transverse axis
Z Vertical axis

What is claimed is:

1-15. (canceled)

16. An agricultural machine comprising:
a frame;
a front axis which is configured to be steerable;
a rear axis which is configured to be steerable;
a trigger element which is configured to be deflected depending on a front axis deflection of the front axis; and
a transmission device comprising a trigger part and a steering part, the steering part being configured to steer the rear axis,
wherein,
the trigger element is further configured to act on the trigger part and to at least partially deflect the trigger part in a deceleration steering mode of the agricultural machine when an absolute amount of the front axis deflection exceeds a threshold value, and
the transmission device is configured to deflect the rear axis in an opposite direction to the front axis as a result of the at least partial deflection of the trigger part and by transmitting a force from the trigger part to the steering part.

17. The agricultural machine as recited in claim 16, further comprising:
a drawbar element which is configured to be swiveled relative to the frame about a drawbar axis, to at least indirectly couple to a towing vehicle which pulls the agricultural machine, and to transmit a tractive force,
wherein,
the front axis is forcibly steered by the drawbar element in the deceleration steering mode.

18. The agricultural machine as recited in claim 17, wherein at least the front axis comprises an Ackerman steering.

19. The agricultural machine as recited in claim 18, further comprising:
a drawbar tie rod; and
a steering knuckle,
wherein,
the drawbar element is connected in an articulated manner to the steering knuckle via the drawbar tie rod.

20. The agricultural machine as recited in claim 18, wherein the trigger element is connected to the drawbar element.

21. The agricultural machine as recited in claim 16, wherein a power transmission from the trigger part to the steering part is interrupted in a single steering mode of the agricultural machine.

22. The agricultural machine as recited in claim 16, wherein,
the trigger part comprises at least one trigger cylinder,
the steering part comprises at least one steering cylinder,
each of the at least one trigger cylinder and the at least one steering cylinder comprises a cylinder body which is configured to receive a working fluid and a piston element which is displaceable relative thereto, and
in the deceleration steering mode, the at least one trigger cylinder is fluidically coupled to the at least one steering cylinder.

23. The agricultural machine as recited in claim 22, wherein the at least one trigger cylinder and the at least one steering cylinder are each designed as hydraulic cylinders.

24. The agricultural machine as recited in claim 22, wherein the trigger element comprises at least one trigger finger which is configured to act on and to displace the piston element of the at least one trigger cylinder.

25. The agricultural machine as recited in claim 22, wherein,
the trigger part comprises two of the at least one trigger cylinder, and
the trigger element is configured to act on one of the two of the at least one trigger cylinders depending on a deflection direction of the front axis.

26. The agricultural machine as recited in claim 22, wherein,
the piston element of the at least one trigger cylinder comprises a first piston part of the trigger cylinder and a second piston part of the trigger cylinder, and
the at least one trigger cylinder further comprises,
a division wall which is arranged in the cylinder body,
a piston rod of the trigger cylinder which is configured to connect the first piston part of the trigger cylinder and the second piston part of the trigger cylinder, the piston rod of the trigger cylinder being guided through the division wall,
a trigger cylinder first chamber which is arranged between the first piston part of the trigger cylinder and the division wall, and
a trigger cylinder second chamber which is arranged between the division wall and the second piston part of the trigger cylinder,
wherein,
in the deceleration steering mode, the trigger cylinder first chamber and the trigger cylinder second chamber are each fluidically connected to one of the at least one steering cylinder.

27. The agricultural machine as recited in claim 26, further comprising:
a pressure accumulator,
wherein,
the cylinder body of the at least one trigger cylinder further comprises an end wall,
at least one of the at least one trigger cylinder further comprises a trigger cylinder third chamber which is arranged between the second piston part of the trigger cylinder and the end wall of the cylinder body, and
the trigger cylinder third chamber communicates with the pressure accumulator in the deceleration steering mode, whereby the at least one trigger cylinder is reset to a basic position.

28. The agricultural machine as recited in claim 22, wherein,
the steering part further comprises a steering cylinder, a piston part of the steering cylinder, and a piston rod of the steering cylinder,
the steering cylinder comprises a first chamber of the steering cylinder and a second chamber of the steering cylinder,
the second chamber of the steering cylinder is separated from the first chamber of the steering cylinder via the piston part of the steering cylinder,
the piston part of the steering cylinder is connected to the piston rod of the steering cylinder, and
a deflection of the piston rod of the steering cylinder deflects the rear axis.

29. The agricultural machine as recited in claim 28, wherein,
the at least one trigger cylinder comprises a first trigger cylinder and a second trigger cylinder, and
in the deceleration steering mode,
the trigger cylinder first chamber of the first trigger cylinder and the trigger cylinder second chamber of the second trigger cylinder are fluidically connected to the first chamber of the steering cylinder, and
the trigger cylinder second chamber of the first trigger cylinder and the trigger cylinder first chamber of the second trigger cylinder are fluidly connected to the second chamber of the steering cylinder.

30. A steering system for an agricultural machine, wherein the agricultural machine comprises:
a frame;
a front axis which is configured to be steerable; and
a rear axis which is configured to be steerable,
the steering system comprising:
a trigger element which is configured to be deflected depending on a front axis deflection of the front axis; and
a transmission device comprising a trigger part and a steering part, the steering part being configured to steer the rear axis,
wherein,
the trigger element is further configured to act on the trigger part and to at least partially deflect the trigger part in a deceleration steering mode of the agricultural machine when an absolute amount of the front axis deflection exceeds a threshold value, and
the transmission device is configured to deflect the rear axis in an opposite direction to the front axis as a result of the at least partial deflection of the trigger part and by transmitting a force from the trigger part to the steering part.

31. A method for steering an agricultural machine, wherein the agricultural machine comprises:
a frame;
a front axis which is configured to be steerable;
a rear axis which is configured to be steerable;
a trigger element which is configured to be deflected depending on a front axis deflection of the front axis; and
a transmission device comprising a trigger part and a steering part, the steering part being configured to steer the rear axis,
the method comprising:
the trigger element acting on the trigger part to at least partially deflect the trigger part in a deceleration steering mode of the agricultural machine when an absolute amount of the front axis deflection exceeds a threshold value; and
the transmission device deflecting the rear axis in an opposite direction to the front axis as a result of the at least partial deflection of the trigger part and transmitting a force from the trigger part to the steering part.
